(19) United States
(12) Patent Application Publication
(10) Pub. No.: US 2014/0278940 A1
(43) Pub. Date: Sep. 18, 2014

(54) SYSTEM, METHOD, AND COMPUTER-READABLE PROGRAM FOR PROVIDING SCHEDULED AND RELEVANT ADVERTISEMENT CONTENT

(71) Applicant: Bryan Wade, Indianapolis, IN (US)

(72) Inventor: Bryan Wade, Indianapolis, IN (US)

(73) Assignee: EXACTTARGET, INC., Indianapolis, IN (US)

(21) Appl. No.: 14/170,431

(22) Filed: Jan. 31, 2014

Related U.S. Application Data
(60) Provisional application No. 61/794,075, filed on Mar. 15, 2013.

(51) Int. Cl. G06Q 30/02

(52) U.S. Cl. CPC G06Q 30/0264
USPC 705/14.45; 705/14.61; 705/14.58

(57) ABSTRACT

A computerized method and system for providing scheduled and relevant advertisement content in electronic marketing communications is disclosed. The method includes receiving a plurality of advertisement content at a server, each advertisement content of the plurality of advertisement comprising a media content corresponding to a marketing advertisement and an expiration data corresponding to an expiration date for the marketing advertisement, associating each advertisement content of the plurality of advertisement content with a content type in a database, the content type identifying a geographic location that is relevant to each advertisement content, assigning a priority to each advertisement content of the plurality of advertisement content in the database, the priority based at least on part on the content type, creating an advertisement schedule for the plurality of advertisement content based at least in part on the priority, content type, and expiration data associated with each advertisement content of the plurality of advertisement content with the server, creating at least one electronic message for a recipient with the server, the at least one electronic message comprising at least one advertisement content selected from the plurality of advertisement content based on the advertisement schedule and at least one demographic attribute of the recipient.

### PRIORITY

This application claims priority to and the benefit of U.S. Provisional Application No. 61/794,075, filed on Mar. 15, 2013, which is incorporated herein by reference.

### BACKGROUND

With the establishment of social media and the ever-increasing adoption of mobile devices, the amount of information available to customers is vast and the amount of time in which such information is relevant continues to become shorter. As such, enterprises must quickly communicate messages to their customers before each message becomes irrelevant or stale. Today, marketing teams spend time manually organizing and approving requests to include advertisements in various communications. In some examples, marketing teams utilize an entire team of persons with complicated spreadsheets and reports to manage content within communications. Based on information in these reports, the marketing team manually customizes communications for individual customers to include appropriate advertisements. Unfortunately, the marketing process used today creates a high risk of error and is time consuming, which can result in irrelevant or stale advertising messages being delivered to customers or potential customers.

Accordingly, there exists a need for a system and method to provide scheduled advertisement content in marketing communications.

### BRIEF DESCRIPTION OF THE DRAWINGS

FIG. 1A displays a flowchart of a method for providing scheduled and relevant advertisement content according to at least one embodiment of the present disclosure.

FIG. 1B displays a flowchart of a method for providing scheduled and relevant advertisement content according to at least one embodiment of the present disclosure.

FIG. 2 displays a flowchart of a method for providing scheduled and relevant advertisement content according to at least one embodiment of the present disclosure.

FIG. 3A displays components of a system for providing scheduled and relevant advertisement content according to at least one embodiment of the present disclosure.

FIG. 3B displays a flowchart of a method and components of a system for providing scheduled and relevant advertisement content according to at least one embodiment of the present disclosure.

FIG. 4A displays an example communication generated through execution of a method through components of a system for providing scheduled and relevant advertisement content according to at least one embodiment of the present disclosure.

FIG. 4B displays example communications and graph corresponding to schedule and priority generated through execution of a method through components of a system for providing scheduled and relevant advertisement content according to at least one embodiment of the present disclosure.

FIG. 5 displays a wireframe mockup of example communications and corresponding communication templates through execution of a method or system for providing scheduled and relevant advertisement content according to at least one embodiment of the present disclosure.

FIG. 6A displays a wireframe template of a graphical user interface generated through execution of a method or system for providing scheduled and relevant advertisement content according to at least one embodiment of the present disclosure.

FIG. 6B displays a wireframe template of a graphical user interface generated through execution of a method or system for providing scheduled and relevant advertisement content according to at least one embodiment of the present disclosure.

FIG. 6C displays a wireframe template of a graphical user interface generated through execution of a method or system for providing scheduled and relevant advertisement content according to at least one embodiment of the present disclosure.

FIG. 6D displays a wireframe template of a graphical user interface generated through execution of a method or system for providing scheduled and relevant advertisement content according to at least one embodiment of the present disclosure.

FIG. 6E displays a wireframe template of a graphical user interface generated through execution of a method or system for providing scheduled and relevant advertisement content according to at least one embodiment of the present disclosure.

FIG. 6F displays a wireframe template of a graphical user interface generated through execution of a method or system for providing scheduled and relevant advertisement content according to at least one embodiment of the present disclosure.

FIG. 7 displays a wireframe mockup of example communications and corresponding communication templates through execution of a method or system for providing scheduled and relevant advertisement content according to at least one embodiment of the present disclosure.

### DETAILED DESCRIPTION

In the present disclosure, a system, method, and computer-readable program for providing scheduled advertisement content is disclosed. The system, method, and computer-readable program disclosed herein enable an entity, entities, individual, or individuals (e.g., enterprise, marketing team, and others) to schedule and send relevant communications to customers, potential customers, and/or others with advertising content that follows a schedule, campaign criteria, and/or other characteristics. In addition, the system, method, and computer-readable program disclosed herein facilitate approval of the selection of certain advertising content and its schedule in order to avoid errors in such communications.

The system, method, and computer-readable program described in the present disclosure enable the configuration of certain communications by a user and of content within such communications. It should be appreciated that the system, method, and computer-readable program disclosed herein may be implemented with various communication platforms, such as, for example, email, SMS, MMS, Facebook, Twitter, LinkedIn, within mobile stand-alone applications, and others.

While this disclosure has been described as having various embodiments, these embodiments according to the present disclosure can be further modified within the scope and spirit of this disclosure. This application is therefore intended to cover any variations, uses, or adaptations of the disclosure using its general principles. For example, any methods disclosed herein represent one possible sequence of performing the steps thereof. A practitioner may determine in a particular implementation that a plurality of steps of one or more of the disclosed methods may be combinable, or that a different sequence of steps may be employed to accomplish the same results. Each such implementation falls within the scope of the present disclosure as disclosed herein and in the appended claims. Furthermore, this application is intended to cover such departures from the present disclosure as come within known or customary practice in the art to which this disclosure pertains.

Referring now to FIG. 1A, a method for providing advertising content on a schedule 100 according to at least one embodiment of the present disclosure is shown. As shown in FIG. 1A, the method 100 includes the steps of creating ad content in step 101, creating email template in step 102, creating an ad schedule in step 103, and approving ad requests in 104.

In at least on embodiment of the present disclosure, the method 100 includes creating ad content in step 101. An enterprise intending to distribute communications to its customers or potential customers may have content focused on advertisements that they wish to include in such communications. In addition, the ad content may include a variety of types, exist in a variety of forms, have certain metrics associated with the ad content, and so forth. As used in the present disclosure, ad content may include, but is not limited to static content, such as, for example, an image, text block, video, or combination thereof, dynamic content, such as, for example, content that is based on certain demographics of the recipients, such as is disclosed in U.S. patent application Ser. No. 10/769,095, incorporated herein by reference, or AMPScript calls, and live content, such as, for example, content that is directed to generate time-specific materials on the opening of a communication, such as is disclosed in U.S. patent application Ser. No. 12/919,982, incorporated herein by reference. It should be appreciated that ad content may include any type of content that may be included within a communication to a recipient. It should be appreciated that step 101 is an optional step and that ad content may already exist. As used in the present disclosure, AMPScript refers to a scripting language that may be embedded in communications and landing pages which directs a rendering agent to render content defined in AMPScript individually for the recipient based on information known about the recipient by an enterprise. For example, a mail client rendering an advertisement defined in AMPScript may request a resource from an enterprise over a computer network with identification of the recipient in the call such that the enterprise retrieves specially tailored content for the recipient based on information known about the recipient by the enterprise. AMPScript may be used to generate unique coupons, targeted advertising, and any specific content directed to an individual consumer.

In at least one embodiment of the present disclosure, an enterprise creates certain ad content to include in its communications in step 101. In at least one embodiment of the present disclosure, the enterprise may upload ad content to an online communications services provider through a portal, such as, for example, through a software as a service model presented by the communications services provider available on the Internet. In such an embodiment, an enterprise user may login to the portal using an account provided by the online communications services provider and interact with a graphical user interface that is configured to accept ad content as input. In such an embodiment, the enterprise user may create and save various types of ad content in the online portal for use in one or more communications or for later use. In such an embodiment, the portal may enable the enterprise user to create ad content through a step-by-step wizard, the enterprise user may directly upload pre-generated ad content directly to the portal, and/or the enterpriser user may reference locations on the Internet where additional ad content may be retrieved. In such an embodiment, the portal enables the enterprise user to create, reference, upload, or otherwise generate ad content to be used in communications that may ultimately be sent by the communications services provider in an advertising campaign.

For example, an enterprise may wish to create ad content that is directed to a concert offered in Chicago, Ill. next month. In this example, the enterprise may create an ad content that includes a static image referencing the concert, an AMPScript call that populates the zip code of the recipient and determines and displays the distance of the recipient to Chicago, Ill., and a pre-generated live content area that displays the local weather for Chicago, Ill. on the day the communication is read by the recipient. In this example, the enterprise user may create this ad content offline, save the ad content as a template, and then upload the ad content to the online portal. In another example, the online portal may enable the enterprise user to create the ad content directly through the online portal in a step-by-step wizard.

In at least one embodiment of the present disclosure, the enterprise may receive certain ad content from a third party provider in step 101. In such an embodiment, ad content received from a third party provider may include, but is not limited to, special coupons, discounts, deals, promotional offerings, information, and other types of content used by a third party to market their products or the products of another. In at least one embodiment of the present disclosure, ad content received from a third party may be uploaded to an online portal provided by a communications services provider that generates and executes marketing campaigns on behalf of the enterprise. In such an embodiment, the third party may interact with the online portal through an application programming interface to upload the ad content.

In at least one embodiment of the present disclosure, an enterprise may make a request for ad content in step 101. In at least one embodiment of the present disclosure, the ad request includes certain information and settings about the ad. The ad request may include information like the name of the advertisement, a country that is specific to the advertisement, a market where the advertisement is relevant, a designated marketing area, the preferred location in a communication where the advertisement should be placed, certain demographic information that may be pertinent to the advertisement, and the priority of the advertisement. In at least one embodiment of the present disclosure, the ad request also includes the actual ad content or a reference to a location where the actual ad content may be retrieved.

For example, an entity creating a request for ad content which includes a 10% off coupon to a rock show in Chicago, Ill. may create an ad request. In this example, the ad request may designate the relevant market of Illinois, choose a preferred zone to include in an email in the body of the message, and reference a URL where an image may be retrieved that includes the ad content.

In at least one embodiment of the present disclosure, the enterprise assigns an ad content type to ad content that is created in step 101. In such an embodiment, the enterprise may select whether the ad content is associated with a certain type of advertising campaign, such as, for example, a local campaign designed to be distributed only in certain metropolitan areas or a national campaign which may be distributed to recipients on a national level. In this example, if the ad content is associated with a local marketing campaign, then the ad content may be associated with a certain city, state, neighborhood, zip code, or other geographic identifier.

In at least one embodiment of the present disclosure, the method 100 includes creating a communication template in step 102. In such an embodiment, the communication template is a wireframe or preview of a communication that will be generated to a recipient. In such an embodiment, the communication template may include multiple content areas with various types of content referenced in the communication. In at least one embodiment of the present disclosure, at least one of the content areas within the communication template may include a reference to ad content created in step 101. In such an embodiment, the communication template's reference to the ad content designates that the ad content will be generated in any communications sent using the communication template.

In at least one embodiment of the present disclosure, the communication template created in step 102 may include a designation for a certain area of the template to include ad content. In such an embodiment, the communication template may designate that a certain area, or zone, of the communication will include ad content but will not reference a specific ad content to include. In such an embodiment, the communication template will reserve a spot for ad content and require that, during the execution of building the communication, the appropriate ad content be inserted into the communication based on a set of criteria. For example, in the communication template, an enterprise may designate a certain zone of the communication for ad content but not reference or identify a specific ad content to include in the zone. In this example, when the communication template is used to build a communication, the build process populates the zone with a certain ad content based on the instructions of the build process or preferences set in a marketing campaign that directed the creation of the communication, such as, for example, based on the type of ad content associated with the zone.

In at least one embodiment of the present disclosure, the communication template may include one or more content areas or zones designated for advertisements. In such an embodiment, the communication template may name one or more of the zones designated for advertisements to be referenced by an ad schedule for population of appropriate ad content when a communication is created using the communication template. For example, a communication template may include five content areas, one of which is designated for advertising content. In this example, the zone designated for advertising content may be named “Spotlight Campaign”. In this example, when the communication template is used to generate a communication, the name “Spotlight Campaign” associated with a specific zone in the communication template will be used to evaluate what, if any, advertising content should be populated in that zone at the time the communication is created. It should be appreciated that more than one communication template may name one or more zones with the same name. Thus, the same content would be “pulled” if more than one communication template referenced the same zone name for inclusion of ad content.

In at least one embodiment of the present disclosure, the communication template may include a wireframe or preview of any type of communication that may be created using the communication template and sent to a recipient. Communications that may be created through the use of the communication template include, but are not limited to, emails, SMS, MMS, Facebook messages, Twitter direct messages, LinkedIn messages, other social media private or public messages, and a webpage.

In at least one embodiment of the present disclosure, the method 100 includes creating an ad schedule in step 103. In at least one embodiment of the present disclosure, the ad schedule is categorized by zone name to include a prioritized list of ad content to be used in specific designated zones of one or more communication templates on specific days. In such an embodiment, for each designated zone in the ad schedule, a prioritized list of ad content is created for a specific time frame, such as, for example, by day.

In at least one embodiment of the present disclosure, a communication created using a communication template that includes a zone set forth in an ad schedule may include ad content in the zone according to a prioritized list in the ad schedule.

In at least one embodiment of the present disclosure, the prioritized list in the ad schedule sets forth which ad content to include based on demographic information of the sender and/or recipient of the communication. In such an embodiment, the ad content selected for a particular zone in the creation of a communication may vary depending on demographic information of each recipient of the communication, the type of campaign associated with the ad content, or other information. In such an embodiment, the ad content selected for a recipient may be related to the geographic location of the recipient in comparison to the type of campaign associated with the ad content, such as, for example, national, local, or placeholder. It should be appreciated that the ad content may be prioritized in any way to select various ad content in the ad schedule. For example, the ad content may be prioritized by a number of communications needed to be sent using an ad content, the number of impressions needed for an ad content, the distance between the sender of a communication and the recipient, the desired number of conversions for the ad content, any of the foregoing metrics related to an expiration date of the ad content, and other metrics.

Ad content may be prioritized statically by defining attributes related to the ad content when placing the ad content into the ad schedule. In addition, ad content may be prioritized dynamically based on incoming consumer activity.

For example, an ad schedule for the “Spotlight Campaign” zone may include three different ad contents in a prioritized list for Jan. 15, 2013. In this example, the prioritized list may include a local campaign for Chicago, Ill. as a top priority, a local campaign for Illinois, and a national campaign as the lowest priority. In this example, a communication is set to be created using a communication template that includes the Spotlight Campaign zone for three different recipients on Jan. 15, 2013. In this example, the three different recipients reside in Madison, Wis., Chicago, Ill., and Quincy, Ill. In this example, the creation of the communication for each recipient will include ad content based on the prioritized list in the ad schedule. For the recipient in Chicago, Ill., the ad content associated with the local campaign for Chicago, Ill. is included because it is the highest in the priority list and it is directly relevant to someone in Chicago, Ill. For the recipient in Quincy, Ill., the ad content associated with the ad content for Chicago, Ill. is not included in the communication because the recipient in Quincy, Ill. may not find an advertisement with a local campaign of Chicago, Ill. to be relevant. Therefore, the next selection in the prioritized list is evaluated. In this example, the ad content associated with the local campaign of Illinois is included in the communication for the recipient in Quincy, Ill. because a local campaign in Illinois may be directly relevant to a recipient residing in Quincy, Ill. For the recipient in Madison, Wis., the ad content associated with the local campaign of Chicago, Ill. and the local campaign of Illinois are both not included because they may not be directly relevant to a recipient in Wisconsin. Therefore, the third ad content in the prioritized list is selected which is associated with a national campaign. In this example, each communication is created with the ad content selected in the Spotlight Campaign zone. In the event that a communication is requested for the same three recipients on Jan. 16, 2013, the ad schedule may set forth a completely different prioritized list of ad content for that day and, therefore, different ad content may be included for those communications.

In at least one embodiment of the present disclosure, the method 100 includes approving ad requests in step 104. In such an embodiment, requests for the addition of ad content in the ad schedule may be made. In such an embodiment, a request for the addition of ad content in the ad schedule may be submitted by an enterprise user through an online portal provided by a communication services provider. In at least one embodiment of the present disclosure, an ad request submitted through an online portal may include a name of the ad request, a country associated with the ad request, a market associated with the ad request, a zone within a communication template, a reference to an ad content to include, and a schedule for the advertisement. For example, an ad request for an advertisement to a show in Chicago, Ill. may include the name “Chicago, Ill. Rock Show”, a country of the United States of America, a market of Chicago, a zone of “Spotlight Campaign,” a URL reference to ad content on the Internet, and a schedule that designates Jan. 1, 2013. In this example, the ad request, if approved in step 104, will add an entry to an ad schedule for the Chicago, Ill. Rock Show advertisement in the market of Chicago, Ill. in the “Spotlight Campaign” on Jan. 1, 2013. It should be appreciated that step 104 is an optional step and that enterprises may not require ad requests to be approved in executing the steps of the method 100.

In at least one embodiment of the present disclosure, a request for the addition of ad content in an ad schedule submitted through an online portal may include a wizard that enables the creation of ad content. In such an embodiment, ad content may be created, uploaded, or referenced in an ad request in a manner similar to step 101.

Referring now to FIG. 1B, a method for providing scheduled advertising content 120 according to at least one embodiment of the present disclosure is shown. As shown, in FIG. 1B, the method 120 includes combining ad content in step 121 with creative in step 122 with an ad schedule in step 123 with approvals in step 124 to provide communications with scheduled ad content to one or more recipients.

Referring now to FIG. 2, there is shown a flowchart of a method 200 for providing scheduled advertising content according to at least one embodiment of the present disclosure. As shown, in FIG. 2, the method 200 includes the steps of obtaining ad content in step 201, assigning an ad content type in step 202, assigning an ad campaign type in step 203, assigning an ad activity schedule in step 204, and assigning ad demographics in step 205. It should be appreciated that although the steps disclosed herein in the method 200 are displayed in an order in the flowchart of FIG. 2, the steps of the method 200 may be executed in various orders and not every step in the method 200 is essential.

In at least one embodiment of the present disclosure, the method 200 includes obtaining an ad content in step 201. As disclosed herein, in at least one embodiment of the present disclosure, an ad content obtained in step 201 may be obtained in a variety of ways. In at least one embodiment of the present disclosure, an ad content may be obtained by submittal of the ad content through an online portal from a remote device operated by an enterprise user. In such an embodiment, the enterprise user accesses an online portal provided by a communication service provider through a username and password associated with the enterprise. In such an embodiment, the enterpriser user may upload and/or create ad content through the online portal. In at least one embodiment of the present disclosure, ad content may be obtained through submittal of ad content by a third party advertising partner through an application programming interface provided by a communication service provider. In such an embodiment, the third party advertising provider submits ad content for an enterprise to include in its communications.

In at least one embodiment of the present disclosure, the method 200 includes assigning an ad content type to ad content in step 202. In such an embodiment, ad content may be associated with one or more content types, markets, geographic locations, and zones within a communication in step 202. It should be appreciated that associating the ad content with these various types and identifiers enables the population of a data-rich ad schedule for providing relevant advertised content on a schedule to recipients of communications.

In at least one embodiment of the present disclosure, ad content obtained in step 201 may be associated with one of various formats in step 202, such as, for example, dynamic content, static content, live content, or a combination of one or more of these types. For example, ad content may include text as static content, a reference to a third-party resource that populates the local weather of the recipient at the time a communication is opened that includes the ad content, and an AMPScript call that selects different types of content based on demographic information of the recipient of a communication created which includes the ad content.

In at least one embodiment of the present disclosure, ad content obtained in step 201 may be associated with a market in step 202. In such an embodiment, ad content may only be relevant to a specific group of consumers that may be identified by geographic location, age, sex, or other demographic. For example, ad content that includes pictures, text, and video concerning a hard rock show in Chicago, Ill. may be associated with a Chicago, Ill. market. It should be appreciated that by associating the ad content with one or more markets, an ad schedule created which prioritizes the ad content may reference such associations in order to determine priority and achieve market segmentation. It should be appreciated that an ad content associated with a local market in Alaska may be set with a higher priority in ad schedule for the Alaska geographic area than an ad content associated with a national market. It should be appreciated that ad content may be associated with zero, one or any number of markets and that the markets may be identified by one or more demographic identifiers, consumer social media interactions, opt-in lists, or other groupings of consumers for marketing purposes. For example, a market may be identified based on social media accounts that are following a Twitter handle or Facebook fan page.

In at least one embodiment of the present disclosure, the method 200 includes associating ad content with a priority or campaign type in step 203. In such an embodiment, ad content, when created, may be associated with a suggested priority based on the type of message included in the ad content and/or the type of campaign in which the ad content is created. In one example, ad content generated with a focus for a national advertisement campaign may be associated with a national priority, whereas ad content with a focus for a local advertisement campaign may be associated with a local priority. In another example, ad content associated with a third-party agreement which requires that the ad content be included in a certain number of communications may be associated with a high priority until the ad content is included in that certain number of communications. In another example, ad content associated with a time-sensitive advertisement may be given a higher priority than ad content associated with a standard or placeholder advertisement that may be relevant at any time. It should be appreciated that the priority set in step 202 is a suggested priority for any ad content and that the priority selected may be modified during the creation of ad schedule, approval of an ad request in an ad schedule or at any other time.

In at least one embodiment of the present disclosure, ad content may be associated with a priority based on deadline in step 203. In such an embodiment, the deadline may include the date in which a certain number of communications must be sent using the ad content. An enterprise sending communications to recipients may have a deadline to use the ad content based on an agreement with a third party, an internal marketing goal, a key performance indicator, or other need. In at least one embodiment of the present disclosure, the priority may be associated with a set number of communications to use the ad content in order to limit the number of recipients with access to a coupon, deal, or promotion offered within the ad content. For example, ad content submitted which includes a picture and link directing the recipient to purchase a movie ticket may be associated with a deadline that corresponds with the release of the movie in theatres and a set number of communications in which the ad content must be used. In another example, ad content submitted which includes an exclusive coupon only intended for five-hundred recipients may be set with a priority that limits distribution of the ad content to only five-hundred users. In this example, by associating the ad content with a priority that limits the use of the ad to only 500 communications, an ad schedule that includes this ad content will be directed to set the ad content at a priority where it is not included in any outgoing communications because the 500-unit maximum is reached.

It should be appreciated that the priority may also be based on a desired number of impressions, conversions, or other consumer activity generated from interaction with the ad content. For example, an enterprise may desire to receive 500 impressions of the ad content, meaning that 500 users have opened an email including the ad content. A priority may be set with the ad schedule such that the ad content is included in outgoing communications at a relatively high rate. As consumers interact with the communications including the ad content and generate impressions, the ad schedule may dynamically deprioritize the ad content to include the ad content in less outgoing communications in order to try to hit the desired 500 impressions. It should be appreciated, of course, that not all recipients open emails and it may be difficult to dynamically adjust the priority of the ad content such that it achieves a perfect amount of impressions. It should be appreciated, though, that a dynamically adjusted priority for ad content enables an enterprise to better control the number of impressions related to a goal number.

In at least one embodiment of the present disclosure, the method 200 includes the step of assigning an ad activity schedule in step 204. In such an embodiment, ad content obtained and associated with various types and identifiers may be set in an ad schedule in step 204. An ad schedule, as used herein, includes a time-based schedule that prioritizes ad content to include in communications for one or more zones of the communications. In at least one embodiment of the present disclosure, ad content may be assigned a slot in an ad schedule associated with a specific timeframe, such as, for example, a day. In such an embodiment, ad content may be prioritized against other ad content also associated with the same timeframe. For example, for Jan. 4, 2013, an ad content associated with a national campaign may be included in a lower priority slot in the ad schedule than an ad content associated with a local campaign. An example of an ad schedule is shown in FIG. 6E.

In at least one embodiment of the present disclosure, the method 200 includes assigning certain ad demographics to ad content in step 205. In such an embodiment, ad content may only be relevant to recipients of certain demographics and, therefore, assigned a higher priority for inclusion in communications to recipients that match certain demographics and assigned a lower priority for inclusion in communications to recipients that do not match those certain demographics. For example, ad content that includes a picture of a coupon for an R-rated movie may be associated with a demographic for persons over the age of 17. In this example, persons under the age of 17 may not find the coupon relevant because of an age restriction to actually use the coupon.

In at least one embodiment of the present disclosure, communications may be created with one or more zones assigned in the communications that reference an ad schedule. In such an embodiment, when the communications are created, the ad schedule is referenced to determine the appropriate ad content to include in the one or more zones of the communication. For example, communications created for a group of one thousand recipients on Jan. 1, 2013 may include a zone titled “Ad Campaign”. In this example, when each communication is created, the ad schedule is referenced to determine what ad content to include in the “Ad Campaign” zone for the communication. In the event that the ad schedule includes three prioritized ad contents for Jan. 1, 2013 in the “Ad Campaign” zone, then when the communications are created, which ad content is included in the “Ad Campaign” zone will be determined based on the priority. For example, in the event the ad content is prioritized based on the number of communications that each ad content must be used prior to a deadline of Jan. 15, 2013

Referring now to FIG. 3A, there is shown at least one embodiment of the components of the system for providing scheduled advertising content 300 according to the present disclosure. System 300 comprises enterprise device 302, first user device 303, second user device 306, communication service provider server 304, database 305, and computer network 301. For purposes of clarity, only two user devices 306, 303 are shown in FIG. 3A. However, it is within the scope of the present disclosure that the system 300 may have three or more user devices 306, 303 operating at the same time or only one user device. In the embodiment shown in FIG. 3A, enterprise device 302 is operated by an enterprise user. It should be noted that at least in one embodiment of the present disclosure, the enterprise device 302 may not be remote from the other components of the system 300 but may be part of or locally connected to the communication service provider server 304 and the database 305.

The enterprise device 302 may be configured to send ad content, create ad requests, approve ad requests, and generally interact with the communication service provider server 304 via the computer network 301. In addition or alternatively, the enterprise device 302 may be configured to access and utilize an application hosted on communication service provider server 304 to create ad content, approve ad requests, create communication templates, and perform other steps of the methods disclosed herein. Enterprise device 302 includes one or more computers, computing devices, or systems of a type well known in the art, such as a mainframe computer, workstation, personal computer, laptop computer, hand-held computer, cellular telephone, or personal digital assistant. Enterprise device 302 comprises such software, hardware, and componentry as would occur to one of skill in the art, such as, for example, one or more microprocessors, memory systems, input/output devices, device controllers, and the like. Enterprise device 302 also comprises one or more data entry means (not shown in FIG. 3A) operable by users of enterprise device 302 for data entry, such as, for example, a pointing device (such as a mouse), keyboard, touchscreen, microphone, voice recognition, and/or other data entry means known in the art. Enterprise device 302 also comprises a display means (not shown in FIG. 3A) which may comprise various types of known displays such as liquid crystal diode displays, light emitting diode display, and the like upon which information may be display in a manner perceptible to the user.

As described above, the communication service provider server 304 may be configured to receive content from the enterprise device 302, host an application for the enterprise device 302 to build electronic messages with ad content, build ad content, receive ad content, set an ad schedule, and/or establish one or more electronic messages. In at least one embodiment, the communication service provider server 304 accesses the database 305 to associate ad content and ad requests with an ad schedule, communication templates, and other data stored within the database 305 as described herein. The communication service provider server 304 is configured to carry out one or more of the steps of methods described herein. It should be appreciated that the communication service provider server 306 may perform any or all of the steps of the methods disclosed herein.

The user devices 303, 306 are configured to provide input or receive output to/from the communication service provider server 304 to carry out one or more of the steps of the methods described herein. Communication service provider server 306 comprises one or more server computers, computing devices, or systems of a type known in the art. Communication service provider server 306 further comprises such software, hardware, and componentry as would occur to one of skill in the art, such as, for example, microprocessors, memory systems, input/output devices, device controllers, display systems, and the like. Communication service provider server 306 may comprise one of many well-known servers, such as, for example, IBM's AS/400 Server, IBM's AIX UNIX Server, or MICROSOFT's WINDOWS NT Server. In FIG. 3A, communication service provider server 306 is shown and referred to herein as a single server. However, communication service provider server 306 may comprise a plurality of servers or other computing devices or systems interconnected by hardware and software systems know in the art which collectively are operable to perform the functions allocated to communication service provider server 306 in accordance with the present disclosure.

The database 305 is configured to store data extensions, contact attributes, recipient demographic information, content, and other information. Database 305 is “associated with” communication service provider server 304. According to the present disclosure, database 305 can be “associated with” communication service provider server 304 where, as shown in the embodiment in FIG. 3A, database 305 resides on communication service provider server 304. Database 305 can also be “associated with” communication service provider server 304 where database 305 resides on a server or computing device remote from communication service provider server 304, provided that the remote server or computing device is capable of bi-directional data transfer with communication service provider server 304. In at least one embodiment, the remote server or computing device upon which database 280 resides is electronically connected to communication service provider server 304 such that the remote server or computing device is capable of continuous bi-directional data transfer with communication service provider server 304.

For purposes of clarity, database 305 is shown in FIG. 3A, and referred to herein as a single database. It will be appreciated by those of ordinary skill in the art that database 305 may comprise a plurality of databases connected by software systems of a type well known in the art, which collectively are operable to perform the functions delegated to database 305 according to the present disclosure. Database 305 may comprise a relational database architecture or other database architecture of a type known in the database art. Database 305 may comprise one of many well-known database management systems, such as, for example, MICROSOFT's SQL Server, MICROSOFT's ACCESS, or IBM's DB2 database management systems, or the database management systems available from ORACLE or SYBASE. Database 305 retrievably stores information or documents that are communicated to database 305 from user devices 303, 306 or through computer network 301.

Each component in the system 300 communicates with other electronically coupled components through the network 301. The network 301 may include, but is not limited to, the Internet, a WAN, LAN, private network, public network, or any other type of computer network. The communication between any component and another computer may be bidirectional. User devices 303, 306 may include any type of device able to receive a communication from an enterprise or retrieve a communication stored within a service provider where a communication is sent, such as, for example, a smartphone, PDA, tablet, gaming system, personal computer, laptop, and cell phone. For example, user devices 303, 306 may include a smartphone that is able to authenticate to and interact with the Facebook platform to receive communications sent to a user's Facebook account from the enterprise using ad content as described herein.

Referring now to FIG. 3B, it is shown a workflow of a system 320 for providing scheduled advertisement content according to at least one embodiment of the present disclosure. As shown, in FIG. 3B, the workflow 320 includes an ad provider 321, an enterprise user 322, a communication service provider 323, and a communication recipient 324. It should be appreciated that the components shown in the workflow 320 match user activity and/or system activity of components shown in the method 300 in FIG. 3A. For example, the communication recipient 324 in the work flow 320 may be associated with one or more of the users of the user devices 303, 306 in the system 300.

In at least one embodiment of the present disclosure, the workflow 320 includes an ad provider 321 transmitting ad content to a communication service provider 323. In such an embodiment, an ad provider 321 may include a third party ad provider that submits ad content on behalf of an enterprise for inclusion in communications created by the enterprise. In such an embodiment, the ad provider 321 transmits ad content to the communication service provider 323 through an application programming interface, an online portal presented as a software as a service product available through a computer network, an email or other communication, or any other manner in which the ad provider 321 can electronically transmit ad content. In such an embodiment, the ad content transmitted by the ad provider 321 may include ad content that is not associated with any market, priority, ad schedule or any other information. In such an embodiment, the enterprise user 322 may assign content types, markets, priorities, an ad schedule, and other identifiers to the ad content through an online portal provided by the communication service provider 323, such as, for example, a software as a service product offered through a computer network. In at least one embodiment of the present disclosure, the ad content transmitted by the ad provider 321 may include associations with various content types, demographics, markets, a suggested ad schedule, priority, and other information.

It should be appreciated that although the work flow 320 displays an ad provider 321 transmitting ad content to the communication service provider 323, the enterprise user 322 may transmit ad content directly to the communication service provider 323. Therefore, in at least one embodiment of the present disclosure, the ad provider 321 is not a necessary component.

In at least one embodiment of the present disclosure, the work flow 320 includes an enterprise user 322 creating communications with the communication service provider 323. The enterprise user 322 may create such communications in a variety of ways as disclosed herein. For example, the enterprise user 322 may authenticate to an online portal provided by the communication service provider 323 made available through a computer network. In this example, the enterprise user 322 interacts with the online portal provided by the communication service provider 323 to create communication templates for inclusion in marketing campaigns generate on behalf of the enterprise user 322 by the communication service provider 323. In another example, the enterpriser user 322 may upload communication templates directly to the communication service provider 323 through an application programming interface provided by the communication service provider 323 over a computer network. In another example, the communication service provider 323 may exist as software stored at the same location as the enterpriser user 322, and the enterprise user 322 may interact directly with the communication service provider 323 through the software.

In at least one embodiment of the present disclosure, the enterpriser user 322 creates communications through the communication service provider 323. In at least one embodiment of the present disclosure, the enterpriser user 322 creates communications by creating a communication template. In such an embodiment, the communication template defines the content included in a communication that may be repeated for multiple recipients. In such an embodiment, the content included in the template may include ad content designated to one or more zones of the communication template. In such an embodiment, when the communication service provider 323 executes a marketing campaign that generates communications based on the communication template, the ad content referenced in one or more zones of the communication template will be included in each communication generated.

In at least one embodiment of the present disclosure, the enterprise user 322 assigns ad properties to ad content at the communication service provider 323. Ad properties may include, but are not limited to, priority, demographic, market, ad content type, DMA, title, deadline, number of uses required, and other information. It should be appreciated that the enterpriser user 322 may assign the ad properties to the ad content when the enterprise user 322 creates the ad content, after the ad provider 321 transmits the ad content, or at any time when ad content resides at the communication service provider 323. In at least one embodiment of the present disclosure, ad content stored at the communication service provider 323 may be made available to the enterprise user 322 through an online portal offered over a computer network. In at least one embodiment of the present disclosure, the communication service provider 323 may exist as software at the enterprise and may be manipulated by the enterprise user 322. In such an embodiment, the ad content stored at the communication service provider 323, therefore, is stored locally at the enterprise and/or at infrastructure managed by the enterprise.

In at least one embodiment of the present disclosure, the enterprise user 322 creates an ad schedule with the communication service provider 323. In such an embodiment, the ad schedule defines a prioritized list of which ad content to include in communications generated in certain timeframes. In at least one embodiment of the present disclosure, the ad schedule may be manipulated by the enterprise user 322 in an online portal provided by the communication service provider 323. In such an embodiment, the enterprise user 322 may interact with the ad schedule to manually define priorities of ad content, set the timeframe for inclusion in the ad schedule, manage what ad content is included in the ad schedule, and otherwise create a customized ad schedule. An example ad schedule provided to the enterprise user 322 through an online portal over a computer network is shown in FIG. 6E.

In at least one embodiment of the present disclosure, the ad schedule may be created, modified, or otherwise manipulated through an application programming interface over a computer network. In such an embodiment, a remote application, third party advertisement network, component, or other network-enabled resource may create, modify, or manipulate aspects of the ad schedule through the application programming interface. For example, a third party advertisement agency may manipulate an ad schedule through the application programming interface to define priorities of ad content, set the timeframe for inclusion in the ad schedule, management what ad content is included in the ad schedule, and/or update priorities based on information known to the third party advertisement network. In another example, a third party social media advertisement service may use an application programming interface to access and modify the ad schedule based on consumer activity generated in social media, such as, for example, prioritizing an advertisement for a specific brand to a consumer based on the consumer “Like”ing the Facebook page associated with the brand or a consumer's Facebook friend “Like”ing the Facebook page.

In at least one embodiment of the present disclosure, the enterprise user 322 creates a marketing campaign with the communication service provider 323. In such an embodiment, the marketing campaign may reference communications that include ad content. In such an embodiment, when the communication service provider 323 executes the marketing campaign, the communication service provider 323 builds one or more communications. In such an embodiment, the communications created by the communication service provider 323 include ad content in one or more zones defined in the communications by the enterprise use 322 based on the priorities set forth in the ad schedule. In at least one embodiment of the present disclosure, communications created by the communication service provider 323 when executing the marketing campaign are delivered to one or more communication recipients 324.

Referring now to FIG. 4A, it is shown an email 400 with multiple zones 401, 402 that may include ad content as described in at least one embodiment of the present disclosure. In such an embodiment, the email 400 is designed by isolating certain sections or zones of the email and content is set forth to be included in such zones. It should be appreciated that the zones may or may not include or reference ad content and that any content may be included in the zones. In at least one embodiment of the present disclosure, the email 400 may be configured using a communication template that defines email zones 401, 402. In such an embodiment, email zone 401 in the communication template may be associated with ad content directed to a coupon and static image. In such an embodiment, email zone 402 may be associated with AMPScript that pulls in dynamic content for inclusion in the email at the time of building the email based on demographic information of the recipient of the email. It should be appreciated that the email 400 shown in FIG. 4A is representative of one of the types of communications able to be created by the systems and methods disclosed herein and that the same principles may be applied to any communication, not just email.

Referring now to FIG. 4B, it is shown an example of the execution of a method 420 for providing scheduled advertisement content according to at least one embodiment of the present disclosure. In this example, the email 400 shown in FIG. 4A is represented with two zones designated as ad content. In this example, the email 400 shown in FIG. 4A varies based on an ad schedule that defines different ad content for Sunday 421 and Monday 422. In this example, the email 400 shown in FIG. 4A varies based on the market or geographic location of recipients of the email whether that recipient is in Juneau 423 or Chicago 424. This example, therefore, shows how ad content designated to various zones within an email may change based on an ad schedule and market information.

As shown in the example in FIG. 4B, the recipient of an email on Sunday 421 in Juneau 423 is provided with Ad #4 and Ad #3 in the email. An email sent on Sunday 421 to a recipient in Chicago 424 is provided with Ad #1 and Ad #2 in the email. This example details that the ad schedule may provide for different ad content to be included in communications sent on the same day to recipients in different markets or geographic locations. In this example, the selection of the different ad content for distribution may be associated with the type of campaign of the ad content or other priority selection. For example, if Ad #4 includes a local ad for Juneau, then on Sunday, Ad #4 may be selected for inclusion in the email because it is more relevant to a resident of Juneau than the other ad content available. In another example, an enterprise user may simply select that Ad #4 be included in communications sent to Juneau on Sunday in the ad schedule rather than have the selection occur through a prioritized list.

In another example, as shown in FIG. 4B, the email 400 includes different ad content when sent to recipient in Juneau 423 and Chicago 424 on Monday 422. In this example, the emails created to be sent to recipients in Juneau 423 on Monday 422 include Ad #2 and Ad #4 whereas the emails created to be sent to recipients in Chicago 424 on Monday 422 include Ad #1 and Ad #3. In this example, the ad content selected for inclusion between Sunday 421 and Monday 422 is different for both Chicago 424 and Juneau 423. It should be appreciated that the selection of ad content for inclusion in the emails sent to recipients in these geographic locations may be based on an ad schedule as described herein and that the example shown in FIG. 4B is an example of how ad content may be different in different markets on the same day and in different days based on priorities and selection of ad content in an ad schedule. An example of the end result of the email 400 based on the schedule for Sunday 421 in Juneau 423 and Chicago 424 is shown in FIG. 7 with different ad content based on the different geographic locations.

Referring now to FIG. 5, it is shown an example communication template 500 that includes zones designated for ad content. In this example, the communication template 500 includes one or more ad zones 501. When a communication is built using the communication template 500, the ad zones 501 are populate with ad content selected from ad inventory 502. In this example, the ad zones 501 may include ad content directed to the Rockstar Energy Drink Uproar Festival, Florence and the Machine at Molson Canadian Ampitheatre, Old 97's: Too Far to Care Tour and other ad content included in the ad inventory 502. In this example, the ad content selected for inclusion in a communication built from the communication template 500 from the ad inventory 502 may be selected based on an ad schedule which prioritizes which ad content to select based on priority, market, the type of campaign selected, and through other properties described herein.

Referring now to FIG. 6A, it is shown a screenshot of a graphical user interface to create an ad request 600 for providing scheduled advertisement content according to at least one embodiment of the present disclosure. As shown, in FIG. 6A, the graphical user interface requests that an enterprise user provide certain information for the ad request 601, such as for example, name, country, and market, a designated marketing area 602, a preferred zone for inclusion of the ad content 603, and an area to create or upload ad content 604.

In at least one embodiment of the present disclosure, the graphical user interface 600 includes an area for an enterprise user to provide the zone 603 for ad content in an ad request. In such an embodiment, the zone 603 selection identifies where in a communication template the ad content is appropriate to include. In at least one embodiment of the present disclosure, a zone is identified by the type of content that will be included in the zone. For example, a zone titled “Spotlight Ad” may include advertisements that are at an important display position in a communication. In another example, “Footer Ad” as a zone may be set to be included in the footer of a communication. It should be appreciated, however, that zones may be included anywhere in a communication template and that the naming of certain zones for identification is not required.

In at least one embodiment of the present disclosure, the graphical user interface 600 includes an area to create, upload and/or reference ad content 604. In such an embodiment, the area 604 requests that the user provide certain information about the ad content when creating an ad request. In such an embodiment, the area asks that the enterprise user identify the priority of the ad content, the type of ad content, and a space to actually create, upload, or reference the ad content. It should be appreciated that the screenshot 600 shown in FIG. 6A includes only one example of ad content area 604 and that by modifying the drop-down boxes in the ad content area 604, the graphical user interface may change. For example, in the event that the enterprise user selects dynamic content in the ad content area 604, then the graphical user interface 600 may present the enterprise user with a location to provide AMPScript or other applet for the designation of dynamic content. In another example, the ad content area 604 may reference previously uploaded ad content, and the enterprise user may select previously uploaded ad content through the graphical user interface 600.

In at least one embodiment of the present disclosure, the graphical user interface 600 includes the first step in creating an ad request for ad content according to at least one embodiment of the present disclosure. In such an embodiment, an enterprise user populating the graphical user interface 600 will start the process of requesting that ad content be included in one or more communications set forth in an ad schedule.

In at least one embodiment of the present disclosure, after the enterprise user populates the graphical user interface 600, the enterprise user is presented with the graphical user interface 610 shown in FIG. 6B to set the schedule for the ad content in the ad request. In such an embodiment, the graphical user interface 610 may include an online date and offline date 611. In such an embodiment, the online date includes the date in which the ad content first may be set in the ad schedule. It should be appreciated that the online date may be associated with the first day in which the ad content is relevant, such as, for example, the first day a promotion is offered, the first day tickets are available for sale through an advertisement in the ad content, and so forth. In at least one embodiment of the present disclosure, the graphical user interface includes an offline date 611. In such an embodiment, the offline date 611 may be the date in which the ad content should no longer be included in any communication. It should be appreciated that the offline date may be associated with the date in which the ad content is no longer relevant, such as, for example, the final day of a promotion, the date in which tickets are no longer for sale through an advertisement in the ad content, or the date in which a coupon expires offered in the ad content.

In at least one embodiment of the present disclosure, the graphical user interface 610 includes conflict resolution and conflict management 612. In such an embodiment, the conflict management 612 may enable the enterprise user to request that conflicts be manually resolved through the ad schedule, that the ad request overrides all conflicts and is included over another ad content in the event of a conflict, the ad request only be included in dates when there is no ad content already populated in the ad schedule, or another methodology to resolve conflicts in acceptance of the ad request in relationship with existing ad content on the ad schedule. For example, in the event that the ad request includes a request to add ad content to communications in the “Spotlight Ad” zone over the week of Nov. 2, 2012 to Nov. 9, 2012, then the ad request may conflict with other previously approved ad requests for ad content in the “Spotlight Ad” zone during this time. In the add request, in this example, the enterprise user may select that the ad request overrides any other ad content already approved in the ad schedule for the “Spotlight Ad” zone on these dates or the enterprise user may request that the ad content only be included where no other ad content is present in the “Spotlight Ad” zone on these dates. In at least one embodiment of the present disclosure, in the event that the enterprise user selects to manually resolve conflicts in the graphical user interface 610, then the enterprise user may be presented with an interface to resolves such conflicts in various markets 613.

Referring now to FIG. 6C, it is shown a screenshot of a graphical user interface 620 of ad requests that are pending review according to at least one embodiment of the present disclosure. In such an embodiment, the graphical user interface 620 presents an enterprise user with a number of ad requests that the enterprise user may approve, deny, modify, review, delete, or otherwise operate on in the graphical user interface 620. In such an embodiment, each ad request shown in the graphical user interface may display certain information about the ad request that is important for the enterprise user to decide whether to approve or deny the ad request, such as, for example, the zone of the request, the status of the request, the country of the request, the appropriate market, and the online and offline dates of the ad content in the request.

Referring now to FIG. 6D, it is shown a screenshot of a graphical user interface 630 to review an ad request according to at least one embodiment of the present disclosure. In such an embodiment, the graphical user interface 630 includes additional detailed information about the ad request that the enterprise user may review prior to approving or denying the ad request. In such an embodiment, the enterprise user may be presented with an opportunity to offer comments in the event that the ad request is denied. Referring now to FIG. 6E, it is shown a screenshot of a graphical user interface 640 displaying an ad schedule according to at least one embodiment of the present disclosure. As shown in FIG. 6E, the graphical user interface 640 includes an ad schedule 641 that displays what ad content has been approved and included in various dates and in what priority. In this screenshot, the ad schedule 641 is specific to the “Spotlight Campaign”, but it should be appreciated that the ad schedule by may be specific any content zone, be generally applicable to any communication, or be specific to multiple content zones. In this example, the screenshot presents the enterprise user with information about the ad schedule 641, such as, for example, the number of pending ad requests, the number of unused slots in the ad schedule 641, and the number of zones in which an ad schedule is available for review.

Referring now to FIG. 6F, it is shown a graphical user interface 650 of a prioritization hierarchy according to at least one embodiment of the present disclosure. In this screenshot, an enterprise user may manipulate a priority of ad content selected for a specific zone based on a priority list. In this example, national campaigns are prioritized higher than local campaigns and, therefore, in the event a communication is created using the prioritized list, a national campaign ad content will be included prior to a local campaign ad content.

While the description above refers to particular embodiments of the present invention, it will be understood that many modifications may be made without departing from the spirit thereof. The accompanying concepts are intended to cover such modifications as would fall within the true scope and spirit of the present invention. The presently disclosed embodiments are therefore to be considered in all respects illustrative and not restrictive, the scope of the invention being indicated by the appended concepts, rather than the foregoing description, and all changes which come within the meaning and range of equivalency of the concepts are therefore intended to be embraced therein.

What is claimed is:

1. A computerized method for providing scheduled and relevant advertisement content in electronic marketing communications, the method comprising:
receiving a plurality of ad content items at a server, each ad content item comprising a marketing advertisement and an expiration date for the marketing advertisement;
associating each ad content item with a content type in a database, the content type identifying a relevancy factor for each ad content item;
determining a priority score to each ad content item in the database, the priority score based at least in part on the content type and the relevancy factor;
generating a dynamic schedule for the plurality of ad content items based at least in part on the priority score, content type, and expiration date for the marketing advertisement associated with each ad content item through the server; and
providing a plurality of electronic messages to a plurality of recipients using the server, each electronic message comprising at least one ad content item selected from the plurality of ad content items based on the dynamic schedule and at least one attribute of a corresponding recipient of the electronic message.

2. The method of claim 1, wherein the relevancy factor is further based on a geographic area targeted by the marketing advertisement.

3. The method of claim 1, wherein the relevancy factor is further based on a demographic attribute targeted by the marketing advertisement.

4. The method of claim 1, further comprising:
designing an electronic message template, the electronic message template comprising at least one ad content area;
wherein the plurality of electronic messages is based at least in part on the electronic message template and the at least one ad content item is placed in the at least one ad content area when rendered in a mail client.

5. The method of claim 1, wherein each ad content item further comprises a desired number of impressions and the relevancy factor is further based on the desired number of impressions.

6. The method of claim 1, further comprising, wherein each ad content item further comprises a desired number of clicks, the method further comprising:
receiving a click activity of the at least one ad content item from at least one of the plurality of recipients; and
repeating the providing step, wherein the at least one ad content item is selected based at least in part on the desired number of clicks and the click activity.

7. The method of claim 1, wherein the dynamic schedule further comprises a placement for each ad content item for each day of a time period.

8. The method of claim 1, wherein the receiving step is accomplished by pulling the plurality of ad content from a third party advertisement service.

9. A system for providing scheduled and relevant advertisement content, the system comprising:
an enterprise device;
a database; and
a host server operably connected to the enterprise device and the database,
wherein the host server is configured to:
receive a plurality of ad content items, each ad content item comprising a marketing advertisement and an expiration date for the marketing advertisement;
associate each ad content item with a content type in a database, the content type identifying a relevancy factor for each ad content item;
determine a priority score to each ad content item in the database, the priority score based at least in part on the content type and the relevancy factor;
generate a dynamic schedule for the plurality of ad content items based at least in part on the priority score, content type, and expiration date for the marketing advertisement associated with each ad content item; and
provide a plurality of electronic messages to a plurality of recipients, each electronic message comprising at least one ad content item selected from the plurality of ad content items based on the dynamic schedule and at least one attribute of a corresponding recipient of the electronic message.

10. The system of claim 9, wherein the relevancy factor is further based on a geographic area targeted by the marketing advertisement.

11. The system of claim 9, wherein the relevancy factor is further based on a demographic attribute targeted by the marketing advertisement.

12. The system of claim 9, wherein the host server is further configured to:
design an electronic message template, the electronic message template comprising at least one ad content area;
wherein the plurality of electronic messages is based at least in part on the electronic message template and the at least one ad content item is placed in the at least one ad content area when rendered in a mail client.

13. The system of claim 9, wherein each ad content item further comprises a desired number of impressions and the relevancy factor is further based on the desired number of impressions.

14. The system of claim 9, wherein the host server is further configured to pull the plurality of ad content from a third party advertisement service.

15. The system of claim 9, wherein the dynamic schedule further comprises a placement for each ad content item for each day of a time period.

16. A computerized method for providing scheduled and relevant advertisement content, the method comprising:
receiving a plurality of ad content items at a server, each ad content item comprising an interactive marketing advertisement configured to direct a user device to a landing page when clicked on by the user in a mail client and an expiration date for the marketing advertisement;
associating each ad content item with a content type in a database, the content type identifying a relevancy factor for each ad content item;
determining a priority score to each ad content item in the database, the priority score based at least in part on the content type, the relevancy factor, and a desired activity for the corresponding marketing advertisement;
generating a dynamic schedule for the plurality of ad content items based at least in part on the priority score, content type, and expiration date for the marketing advertisement associated with each ad content item through the server; and
sending a plurality of electronic messages to a plurality of recipients using the server, each electronic message comprising at least one ad content item selected from the plurality of ad content items based on the dynamic schedule and at least one attribute of a corresponding recipient of the electronic message;
receiving consumer activity based at least in part on at least one of the plurality of recipients opening at least one of the plurality of electronic messages and clicking on the corresponding marketing advertisement;
updating the priority score for the corresponding ad content item in the database based on the consumer activity and the corresponding desired activity.

17. The method of claim 16, wherein the desired activity identifies a number of clicks of the marketing advertisement.

18. The method of claim 16, wherein the desired activity identifies a number of opens of electronic messages where the marketing advertisement is displayed.

19. The method of claim 16, wherein the consumer activity is a purchase of a product based on interaction with the marketing advertisement.

20. The method of claim 16, further comprising displaying statistics based on the consumer activity related to the desired activity for the marketing advertisement to an enterprise user.
